(19) United States
(12) Patent Application Publication
(10) Pub. No.: US 2026/0344650 A1
(43) Pub. Date: Nov. 5, 2026

(54) ANTI-RODENT TRIM

(71) Applicant: C.P. ROLL FORM INC., Chateau-Richer (CA)

(72) Inventors: Carl PICHETTE, Chateau-Richer (CA); Jason PICHETTE, Quebec (CA)

(21) Appl. No.: 19/660,791

(22) Filed: Apr. 28, 2026

Related U.S. Application Data
(60) Provisional application No. 63/797,569, filed on Apr. 30, 2025.

(51) Int. Cl. A01M 29/30; E04B 1/72

(52) U.S. Cl. CPC A01M 29/30; E04B 1/72

(57) ABSTRACT

An anti-rodent trim for preventing rodents from entering an air gap between a cladding of a building, a wall assembly having the anti-rodent trim, and a method of installing the anti-rodent trim. The anti-rodent trim may include a first section. The anti-rodent trim may include a second section extending from the first section. The anti-rodent trim may include the second section having an undulating profile along at least a portion of a width of the second section. The anti-rodent trim may include the second section defining a plurality of ventilation apertures along the portion of the width of the second section.

### CROSS-REFERENCE

The present application claims priority to United States Provisional Application No.63/797,569, filed on Apr. 30, 2025, which is incorporated herein by reference in its entirety.

### FIELD OF TECHNOLOGY

The present technology relates to an anti-rodent trim.

### BACKGROUND

Buildings with exterior cladding, such as vinyl or wood siding, often include an air gap between the siding and the underlying wall structure to promote ventilation and moisture drainage. While essential for preventing mold and water damage, these gaps can also become entry points for rodents and other pests, which can cause structural damage, including gnawing on insulation, wiring, sheathing, and other internal wall components, and introduce health hazards.

To prevent rodent intrusion, trim pieces are installed at different locations of the wall, such as the base of the wall, to cover the air gap. However, traditional trim designs typically rely on thicker more rigid materials to maintain structural integrity around the air ventilation apertures. The use of thicker materials increases costs and often leads to smaller or fewer ventilation apertures—either to maintain structural integrity or to enhance rodent resistance—ultimately reducing the area available for airflow which may impact ventilation performance of the anti-rodent trim.

In view of the foregoing, there is a need for an anti-rodent trim that addresses at least some of these drawbacks.

### SUMMARY

It is an object of the present technology to ameliorate at least some of the inconveniences present in the prior art.

In one aspect of the present technology, an anti-rodent trim for preventing rodents from entering an air gap between a siding of a building is provided. The anti-rodent trim has a first section; and a second section extending from the first section, the second section having at least one protrusion defined along a profile of the second section, and the second section defining a plurality of ventilation apertures along a width of the second section.

In some embodiments, the at least one protrusion is a series of protrusions forming an undulating profile along at least a portion of the width of the second section.

In some embodiments, an entire width of the second section has the undulating profile.

In some embodiments, the first section and the second section are integrally formed.

In some embodiments, the second section extends from a first surface of the first section; and the anti-rodent trim further includes an extension extending from a second surface of the first section, the second surface being opposite of the first surface.

In some embodiments, the second section extends from a first surface of the first section; and the anti-rodent trim further includes an extension extending from the first surface of the first section and spaced apart from the second section.

In some embodiments, the extension is integrally formed with the first section.

In some embodiments, the extension includes a ridge projecting from the extension, the ridge being spaced apart from the first section.

In some embodiments, the anti-rodent trim further includes a projection extending from the second section, the projection being spaced apart from the first section.

In some embodiments, the projection is integrally formed with the second section.

In some embodiments, each of the plurality of ventilation apertures have a diameter of about 0.125 inches.

In one aspect of the present technology, a wall assembly for a building is provided. The wall assembly includes: a sheathing; a cladding spaced apart from and connected to the sheathing and defining an air gap between the cladding and the sheathing; an anti-rodent trim having: a vertical section contacting at least one of the cladding or the sheathing; and a lateral section extending from the vertical section across at least a portion of the air gap to prevent rodents from entering the air gap, the lateral section having at least one protrusion defined along a profile of the lateral section, and the lateral section defining a plurality of ventilation apertures along a width of the lateral section, the plurality of ventilation apertures being configured to fluidly connect the air gap with outside air for ventilation.

In some embodiments, the wall assembly further includes a plurality of furring strips connected to the sheathing, each of the plurality of furring strips being spaced apart from one another; and wherein: the cladding is connected to the plurality of furring strips; the vertical section of the anti-rodent trim is positioned between the plurality of furring strips and the cladding and is connected to the plurality of furring strips; and the lateral section of the anti-rodent trim is positioned beneath the plurality of furring strips such that a base of each of the plurality of furring strips contacts the lateral section of the anti-rodent trim.

In some embodiments, the wall assembly further includes a plurality of furring strips connected to the sheathing, each of the plurality of furring strips being spaced apart from one another; a window connected to the sheathing; the anti-rodent trim further includes an extension extending from a cladding-facing surface of the vertical section; and wherein: the cladding is connected to the plurality of furring strips; the vertical section of the anti-rodent trim is positioned between the plurality of furring strips and the sheathing and is connected to the sheathing; the lateral section of the anti-rodent trim is positioned beneath the plurality of furring strips such that a base of each of the plurality of furring strips contacts the lateral section of the anti-rodent trim; and the extension of the anti-rodent trim is positioned above the window such that a bottom surface of the extension abuts at least a portion of a top of the window.

In some embodiments, the wall assembly further includes a plurality of furring strips connected to the sheathing, each of the plurality of furring strips being spaced apart from one another; a soffit connected to the sheathing; the anti-rodent trim further includes a projection, the projection having a transverse portion; and wherein: the cladding is connected to the plurality of furring strips; the vertical section of the anti-rodent trim is positioned between the cladding and the plurality of furring strips and is connected to the plurality of furring strips; and the transverse portion of the projection being positioned between the furring strips and the soffit.

In some embodiments, the wall assembly further includes a plurality of furring strips connected to the sheathing, each of the plurality of furring strips being spaced apart from one another; a window connected to the sheathing; the anti-rodent trim further includes a projection projecting from the lateral section, the projection having an upright portion and a transverse portion; and wherein: the cladding is connected to the plurality of furring strips; the vertical section of the anti-rodent trim is positioned between the plurality of furring strips and the cladding and is connected to the plurality of furring strips; and the transverse portion of the projection abuts a bottom of the window.

In some embodiments, the at least one protrusion is a series of protrusions forming an undulating profile along at least a portion of the width of the lateral section.

In one aspect of the present technology, a method of installing an anti-rodent trim for a building is provide. The method includes: positioning the anti-rodent trim such that a lateral section of the anti-rodent trim extends away from a sheathing of the building, the lateral section of the anti-rodent trim having an undulating profile along at least a portion of a width of the lateral section and defining a plurality of ventilation apertures along the portion of the width of the lateral section; and securing a vertical section of the anti-rodent trim to at least one of a plurality of furring strips or a sheathing.

In some embodiments, the method further includes positioning a bottom surface of a cladding against an extension extending from the vertical section of the anti-rodent trim.

In some embodiments, the method further includes positioning a recess defined in the bottom surface of the cladding such that a ridge projecting from the extension of the anti-rodent trim is received in the recess.

As used herein, the term “about” in the context of a given value or range refers to a value or range that is within 20%, preferably within 10%, and more preferably within 5% of the given value or range.

Explanations and/or definitions of terms provided in the present application take precedence over explanations and/or definitions of these terms that may be found in any documents incorporated herein by reference.

Additional and/or alternative features, embodiments and advantages of embodiments of the present technology will become apparent from the following description, the accompanying drawings and the appended claims.

### BRIEF DESCRIPTION OF THE DRAWINGS

For a better understanding of the present technology, as well as other embodiments and further features thereof, reference is made to the following description which is to be used in conjunction with the accompanying drawings, where:

FIG. 1 is a front, left perspective view of a wall assembly of a building having a base anti-rodent trim, according to non-limiting embodiments of the present technology;

FIG. 2 is a top, rear, left side perspective view of a base anti-rodent trim, according to non-limiting embodiments of the present technology;

FIG. 3 is a left plan view of the base anti-rodent trim of FIG. 2

FIG. 4 is a cross-sectional view of a wall assembly having the base anti-rodent trim of FIG. 2;

FIG. 5 is a top, front, right side perspective view of a base anti-rodent trim, according to alternative non-limiting embodiments of the present technology;

FIG. 6 is top, rear, left side perspective view of the base anti-rodent trim of FIG. 5;

FIG. 7 is a left plan view of the base anti-rodent trim of FIG. 5;

FIG. 8 is a cross-sectional view of a wall assembly having the base anti-rodent trim of FIG. 5;

FIG. 9 is top, rear, left side perspective view of a base anti-rodent trim of FIG. 1;

FIG. 10 is a left plan view of the base anti-rodent trim of FIG. 9;

FIG. 11 is a cross-sectional view of a wall assembly having the base anti-rodent trim of FIG. 9;

FIG. 12 is a bottom, front, right side perspective view of an upper anti-rodent trim;

FIG. 13 is a left plan view of the upper anti-rodent trim of FIG. 12;

FIG. 14 is a cross-sectional view of a wall assembly having the upper anti-rodent trim of FIG. 12;

FIG. 15 is a top, front, right side perspective view of an upper window anti-rodent trim;

FIG. 16 is a left plan view of the window anti-rodent trim of FIG. 15;

FIG. 17 is a cross-sectional view of a wall assembly having the upper window anti-rodent trim of FIG. 15;

FIG. 18 are plan views of various embodiments of undulating profiles for a lateral section of an anti-rodent trim;

FIG. 19 is a flow chart depicting a method of installing a base anti-rodent trim;

FIG. 20 is a flow chart depicting a method of installing an upper anti-rodent trim;

FIG. 21 is a flow chart depicting a method of installing a window anti-rodent trim;

FIG. 22 is a left plan view of a base anti-rodent trim, according to alternative non-limiting embodiments of the present technology;

FIG. 23 is a cross-sectional view of a wall assembly having the base anti-rodent trim of FIG. 22;

FIG. 24 are plan views of various embodiments of lateral sections of an anti-rodent trim;

FIG. 25 is a left plan view of a lower window anti-rodent trim; and

FIG. 26 is a cross-sectional view of a wall assembly having the lower window anti-rodent trim of FIG. 25.

### DETAILED DESCRIPTION

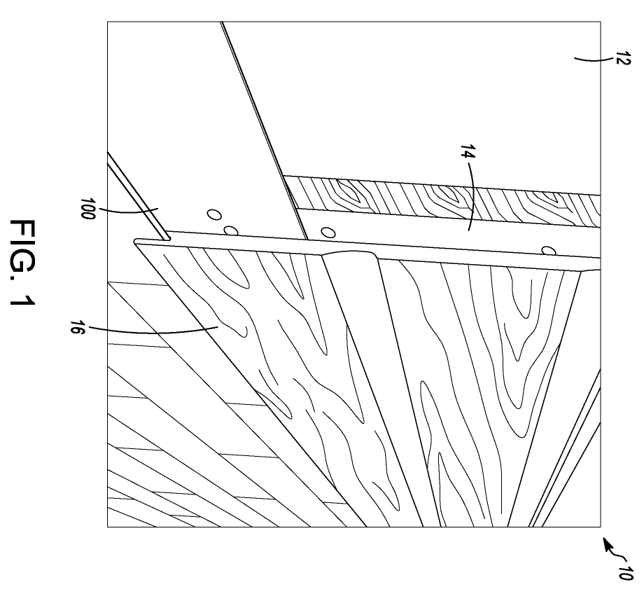

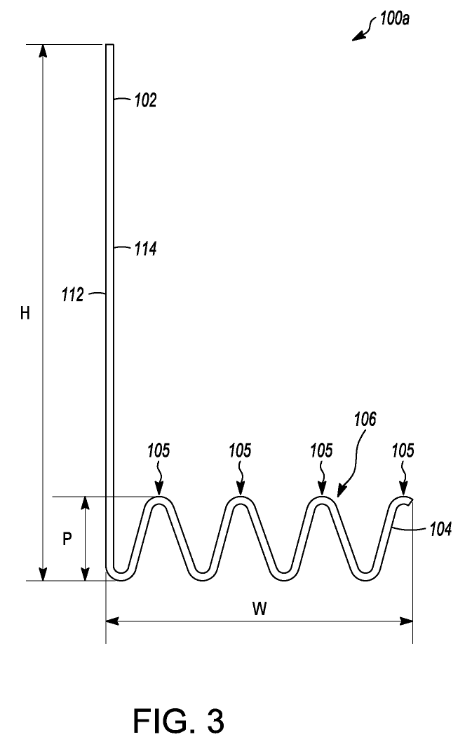

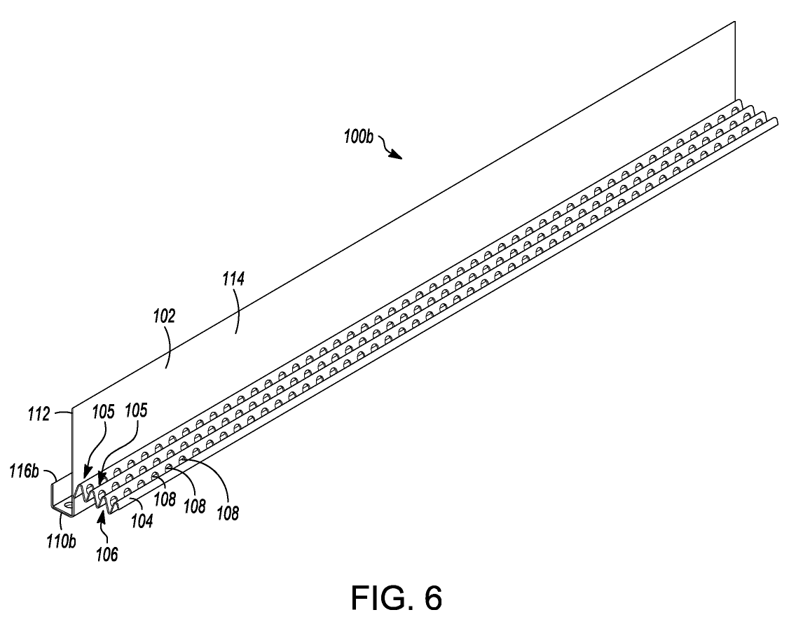

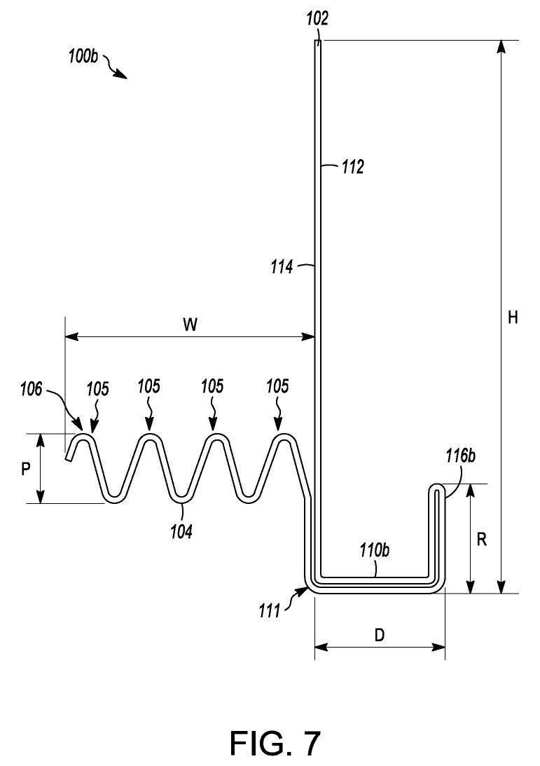

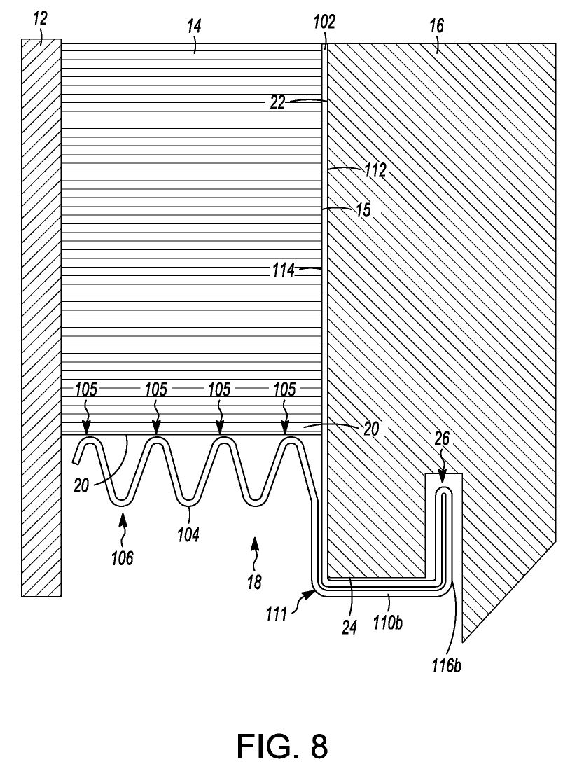

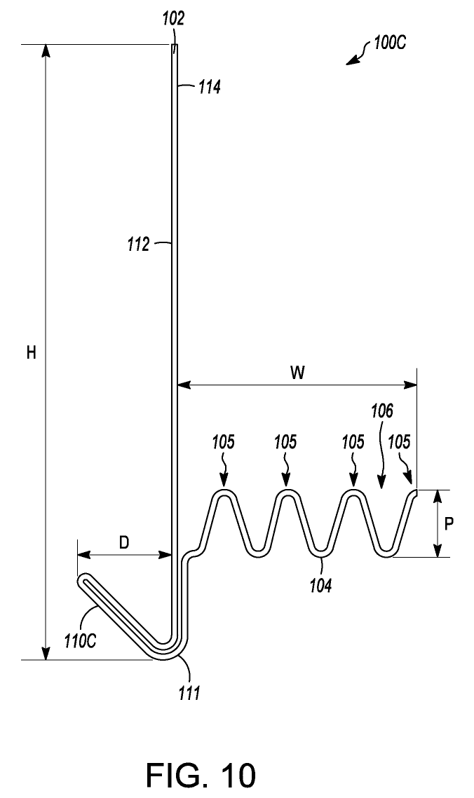

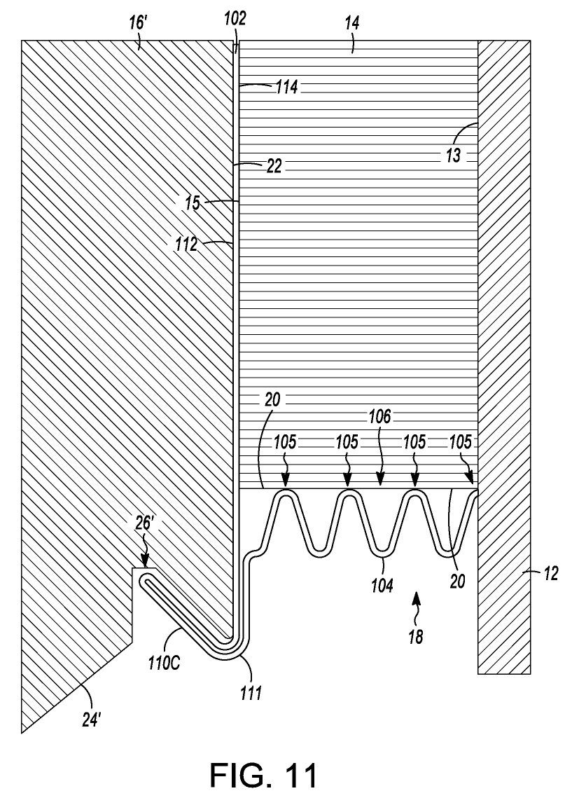

FIGS. 1 to 17, 22, 23, 25, and 26 depict various embodiments of anti-rodent trims 100a, 100b, 100c, 100d, 200, 300, 700 according to the present technology.

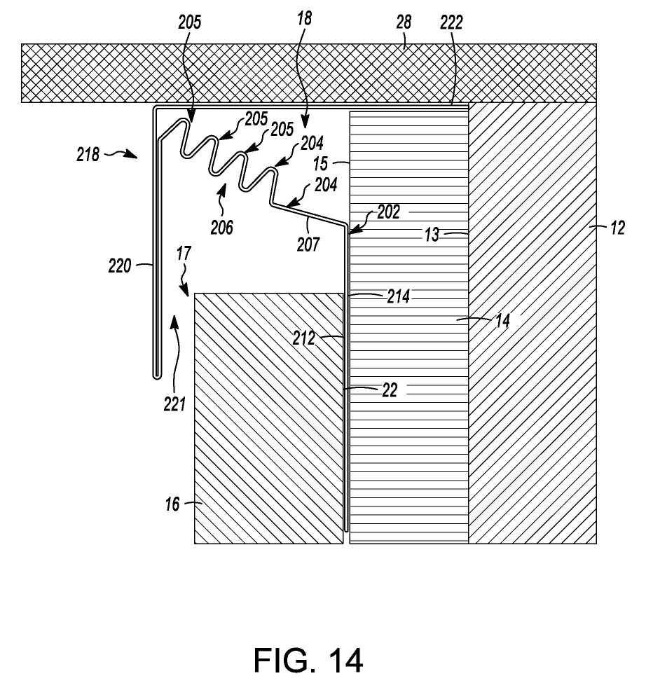

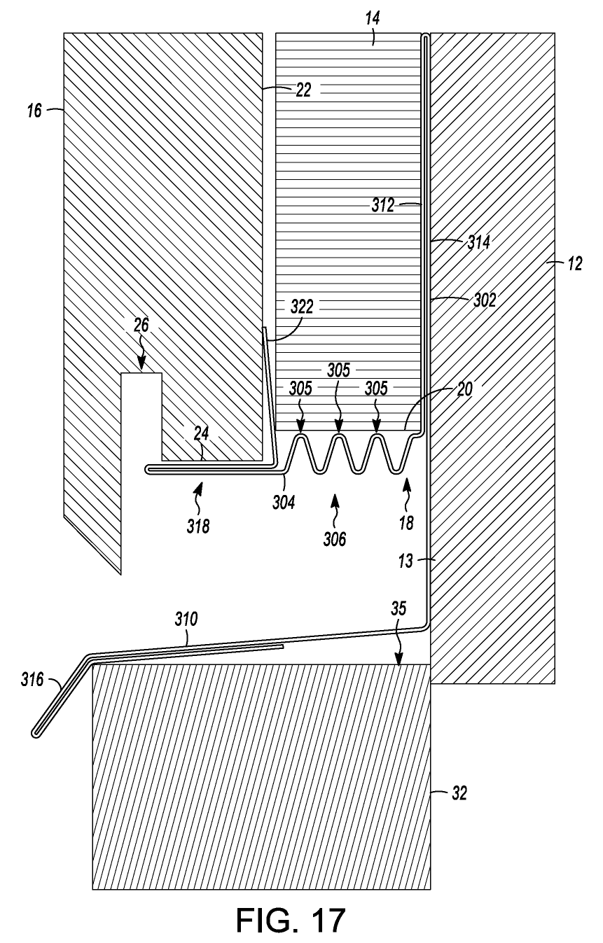

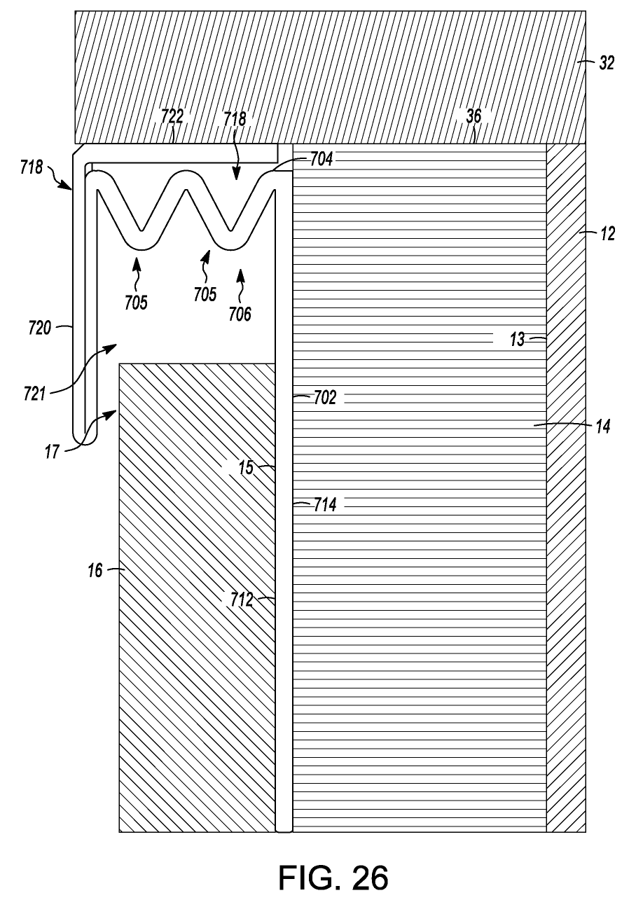

The anti-rodent trims 100a, 100b, 100c, 100d, 200, 300, 700 can each be used within a wall assembly 10 for a building. As shown in FIGS. 1, 4, 8, 11, 23, and 26 the wall assembly 10 of the present embodiment includes a sheathing 12, a plurality of furring strips 14 spaced apart from one another and secured to the sheathing 12, and an exterior cladding 16, 16', 16''. In certain embodiments, the exterior cladding is siding 16, 16', such as a vinyl or wood siding, that is connected to the furring strips 14. However, in certain embodiments, the exterior cladding is brick 16''. The exterior cladding 16, 16', 16'' is spaced apart from the sheathing 12, forming an air gap 18 therebetween to facilitate ventilation and drainage of the wall assembly 10. As depicted in FIG. 14, the wall assembly 10 further includes a soffit 28. As depicted in FIGS. 17 and 26, the wall assembly 10 further includes a window 32. It is noted that, in alternative embodiments, the wall assembly 10 may include additional and/or fewer components. Additionally, while the present technology will be described hereinafter with reference to the siding 16, 16', and brick 16'', other types of exterior cladding including, but not limited to, wood panels, metal panels, fiber cement boards, or stone veneer, and other composite materials, may be used in various embodiments.

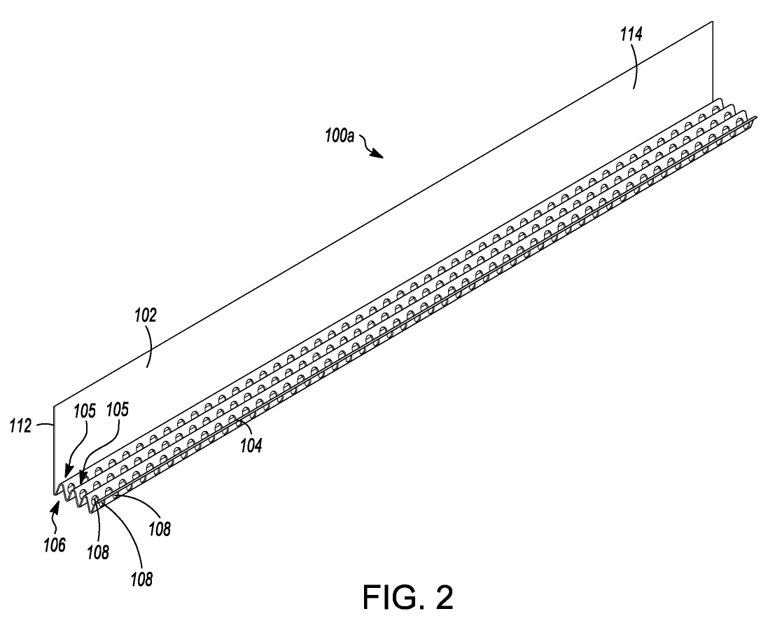

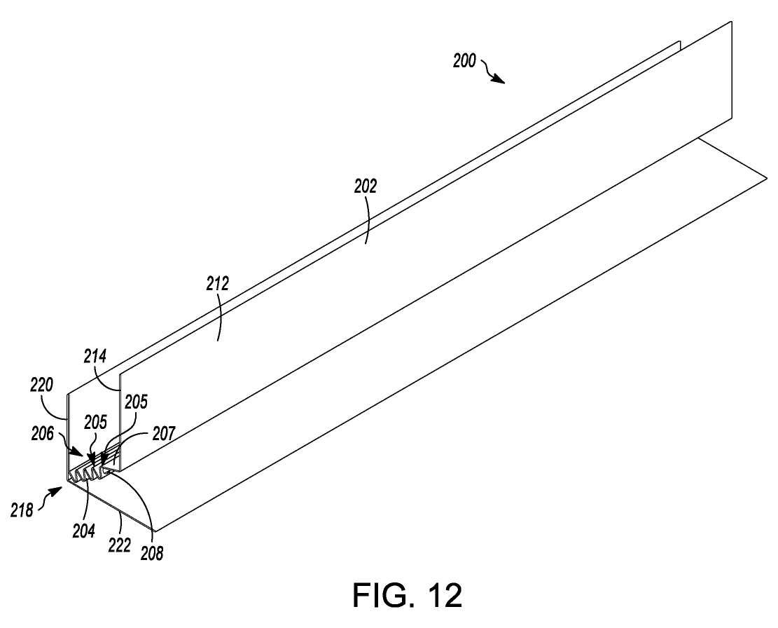

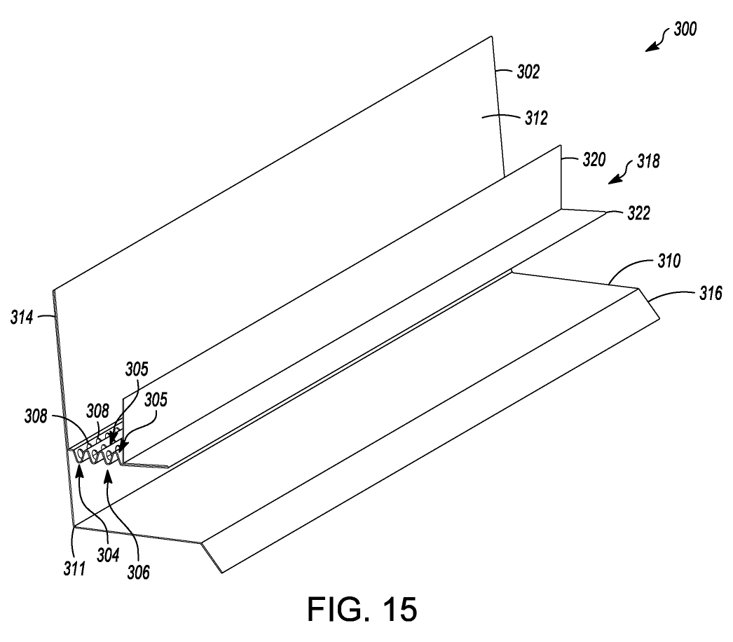

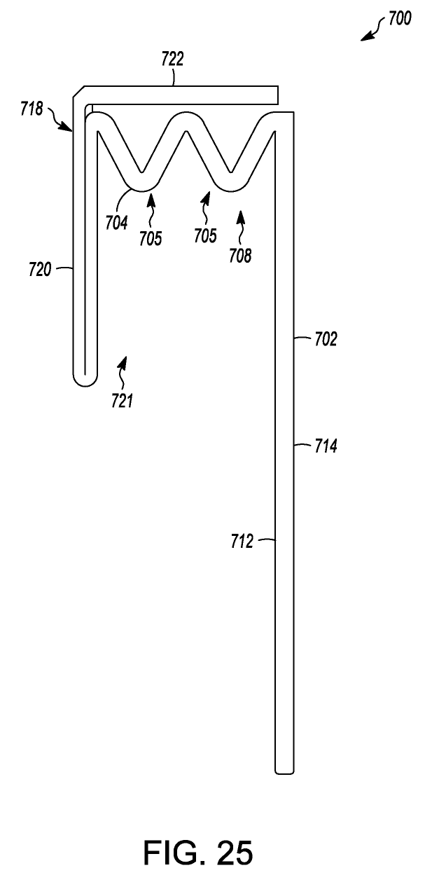

With reference to FIGS. 2 to 11, 22 and 23 the anti-rodent trims 100a, 100b, 100c, 100dare configured as base anti-rodent trims 100a, 100b, 100c, 100d (referred to hereinafter as the anti-rodent trim 100a, 100b, 100c, 100d respectively) configured for placement at a lower portion of the wall assembly 10. In other embodiments, such as those depicted in FIGS. 12 to 17 and 25 to 26, the anti-rodent trim may be located at different positions along the wall assembly 10. For instance, FIGS. 12 to 14 depict an upper anti-rodent trim 200 (referred to hereinafter as the anti-rodent trim 200) configured for use at an upper portion of the wall assembly 10, such as near the roofline. FIGS. 15 to 17 depict an upper window anti-rodent trim 300 (referred to hereinafter as the anti-rodent trim 300) adapted for placement above a window 32, while FIGS. 25 to 26 depict a lower window anti-rodent trim 700 (referred to hereinafter as the anti-rodent trim 700) adapted for placement below the window 32.

With reference to FIGS. 2 to 4, the anti-rodent trim 100awill now be described in detail. The anti-rodent trim 100aincludes a first section 102 and a second section 104 extending from the first section 104. In the present embodiment, when the anti-rodent trim 100a is installed within the wall assembly 10, the first section 102 is oriented in a vertical position and will therefore be referred to hereinafter as the vertical section 102. Similarly, the second section 104 is oriented laterally and will be referred to hereinafter as the lateral section 104.

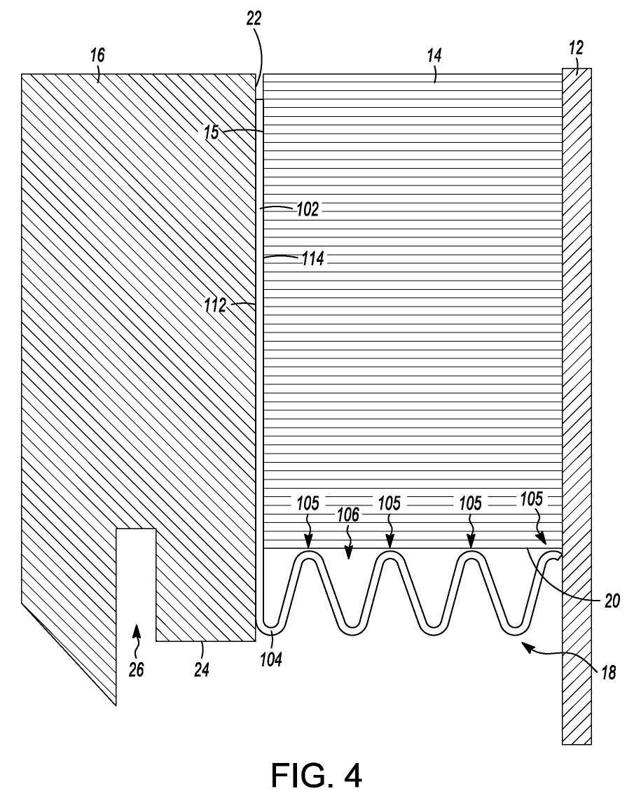

FIG. 4 depicts a close-up of a cross-section of the lower portion of the wall assembly 10 having the anti-rodent trim 100a. In the present embodiment the vertical section 102 of the anti-rodent trim 100a is positioned in contact with and between the siding 16 and the furring strips 14. Specifically, a surface 112 of the vertical section 102 (hereinafter referred to as the cladding-facing surface 112) abuts the inner surface 22 of the siding 16. The vertical section 102 is secured—such as by fasteners (not shown)—to each of the furring strips 14. It is noted that, although the anti-rodent trim 100ais described with reference to the siding 16, it may also be used with the siding 16' or the brick 16'' in other embodiments.

The lateral section 104 extends from an opposite surface 114 of the vertical section 102 (referred to hereinafter as the sheathing-facing surface 114). In the present embodiment, the lateral section 104 of the anti-rodent trim 100a extends substantially perpendicularly to the vertical section 102. However, in other embodiments, the lateral section 102 may extend obliquely to the vertical section 102. The lateral section 104 extends across the air gap 18 towards the sheathing 12 to prevent rodents from entering the air gap 18. The lateral section 104 is positioned beneath the furring strips 14 such that a bottom surface 20 of the furring strips 14 contacts the lateral section 104. However, in some embodiments, the bottom surface 20 of the furring strips 14 may be vertically spaced apart from the lateral section 104. It is contemplated that, in alternative embodiments, the anti-rodent trim 100a may be arranged within the wall assembly 10 differently. For example, in other embodiments, the vertical section 102 may be connected to the sheathing 12 and the lateral section 104 may extend across the air gap 18 towards the siding 16.

In some embodiments, a height (denoted by H) of the vertical section 102 of the anti-rodent trim 100a may range from approximately 1.2 inches (3.0 cm) to 1.8 inches (4.6 cm). In some instances, the height of the vertical section 102 is 1.2 inches (3.0 cm). In another instance, the height of the vertical section 102 is 1.5 inches (3.8 cm). In another instance, the height of the vertical section 102 is 1.8 inches (4.5 cm). In some embodiments, a width (denoted by W) of the lateral section 104 of the anti-rodent trim 100a, corresponding to the distance to the sheathing 12, is approximately 0.7 inches (1.8 cm). It is noted that the height of the vertical section 102 and the width of the lateral section 104 may vary in other embodiments.

In the present embodiment, the anti-rodent trim 100a is integrally formed, such that the vertical section 102 and the lateral section 104 are integrally formed with one another. In alternative embodiments, the vertical section 102 and the lateral section 104 may be formed separately and connected via any suitable method, such as welding.

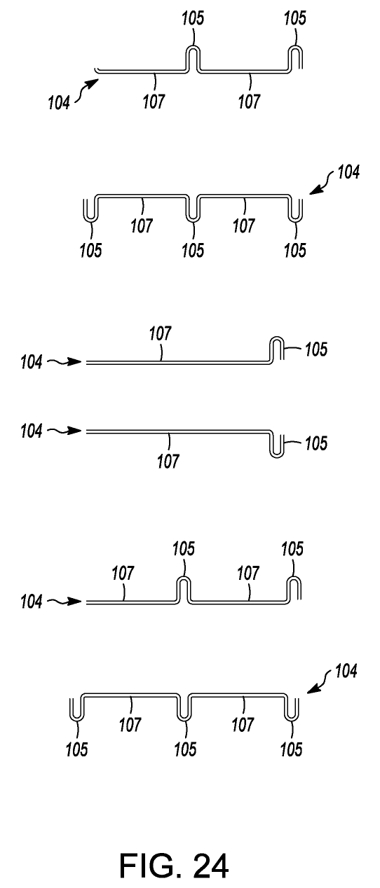

The lateral section 104 includes at least one protrusion 105 defined along the profile of the lateral section 104. As shown in FIG. 24, the lateral section 104 may include a series of protrusions 105—such as two or three—spaced apart along its width by straight sections 107. These protrusions 105 may be evenly or unevenly distributed across the lateral section 104. In some embodiments, a single protrusion 105 may be provided, positioned anywhere along the width, for example, near one end of the lateral section 104. The protrusion(s) 105 may extend either upward, downward, or a combination of both, when the anti-rodent trim 100a is assembled.

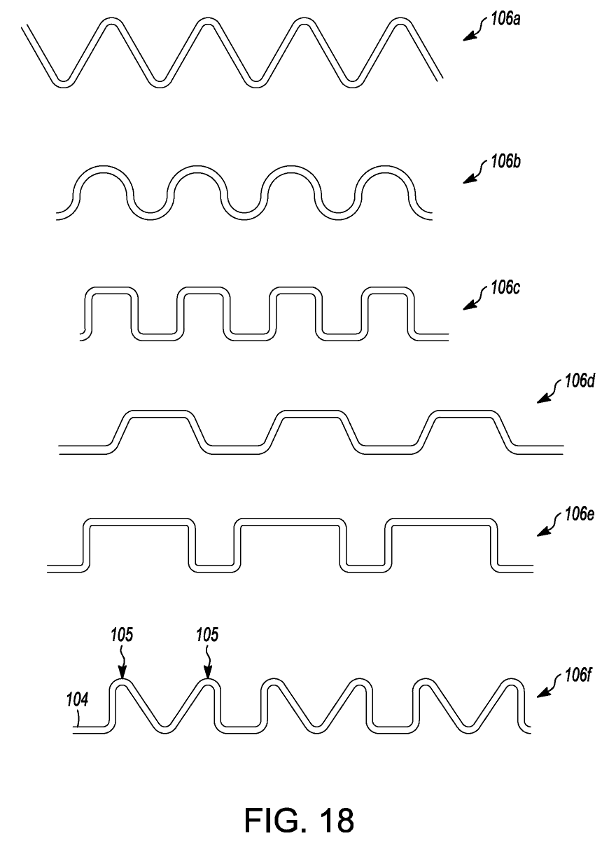

In the present embodiment, the lateral section 104 includes a series of protrusions 105 which form an undulating profile 106 extending along the width of the lateral section 104. As depicted in FIGS. 2 to 4, the undulating profile 106 extends across the entire width of the lateral section 104 of the anti-rodent trim 100a. However, in other embodiments, the undulating profile 106 may extend only along a portion of the width of the lateral section 104. In the present embodiment, the undulating profile 106 is an arcuate waveform having slightly rounded peaks and troughs, forming a continuous wave. It is noted that, in other embodiments, the undulating profile 106 may vary. Alternative undulating profiles 106 are depicted in FIG. 18. For instance, in some embodiments, the undulating profile 106 may include an angular waveform 106a having a zig-zag pattern of substantially triangular peaks and troughs; a smooth curve waveform 106b having substantially rounded peaks and troughs, resembling a sine wave; a narrow rectangular waveform 106c form with a block-like profile; a trapezoidal waveform 106d having a repeating pattern of trapezoidal waves; a wide rectangular waveform 106e having an elongated block-like profile; and a compound waveform 106f having a repeating pattern of multiple different waveform types. In some embodiments, the undulating profile 106 has a height (denoted by P), defined as the distance between a peak and a trough, of approximately 0.2 inches (0.5 cm). However, this may vary in other embodiments.

With continued reference to FIG. 2, the lateral section 104 defines a plurality of ventilation apertures 108 spaced apart from one another. The ventilation apertures 108 provide fluid communication between the air gap 18 with the outside air, allowing for airflow therebetween to facilitate drying out any trapped moisture, preventing mold, rot, and mildew, as well as facilitating drainage of any incidental water which may have entered the air gap 18. In the present embodiment, the lateral section 104 defines approximately 336 ventilation apertures 108 over a length of a 12-inch (30.5 cm) segment. Specifically, the ventilation apertures 108 are arranged in an array comprising seven (7) rows, with each row containing 48 apertures along the 12-inch (30.5 cm) length. In the present embodiment, each ventilation aperture 108 is circular in shape and has a diameter of about 0.125 inches. This configuration provides approximately 40% or more ventilation of the surface area projected by the lateral section 104. In some embodiments, the ventilation is about 50%, but it is contemplated that it may reach up to 65% to 70%. In further embodiments, ventilation may exceed 70%, depending on the thickness and/or type of material used.

In the present embodiment, the ventilation apertures 108 are defined in the lateral section 104. Due to the protrusions 105 and the undulating profile 106, the lateral section 104 has an increased surface area without an increase in the overall width of the lateral section 104 per unit length. As a result, the same number of ventilation apertures 108 can be maintained per unit length of projected area, preserving ventilation performance. Consequently, the ventilation apertures 108 are distributed over a greater surface area, such that fewer ventilation apertures 108 are required per square inch of material, thereby enabling the use of thinner material. In some embodiments, for example when the anti-rodent trim 100a is composed of steel, the thickness may range between approximately 0.015 inches to 0.017 inches (0.381 mm to 0.432 mm). In other embodiments, for example when the anti-rodent trim 100a is composed of aluminum, the thickness may range between approximately 0.017 inches to 0.021 inches (0.432 mm to 0.533 mm). It is noted that other thicknesses and materials are contemplated.

Additionally, the protrusions 105 and the undulating profile 106 enhances the structural rigidity and reinforcement of the lateral section 104, ensuring that the structural integrity of the lateral section 104 is maintained despite the reduced material thickness. This allows for cost savings without compromising the ventilation performance and structural strength of the anti-rodent trim 100a. Alternatively, in other embodiments, a thicker material may be used, with the density and/or size of the ventilation apertures 108 adjusted to increase the overall ventilation surface area, thereby improving ventilation performance.

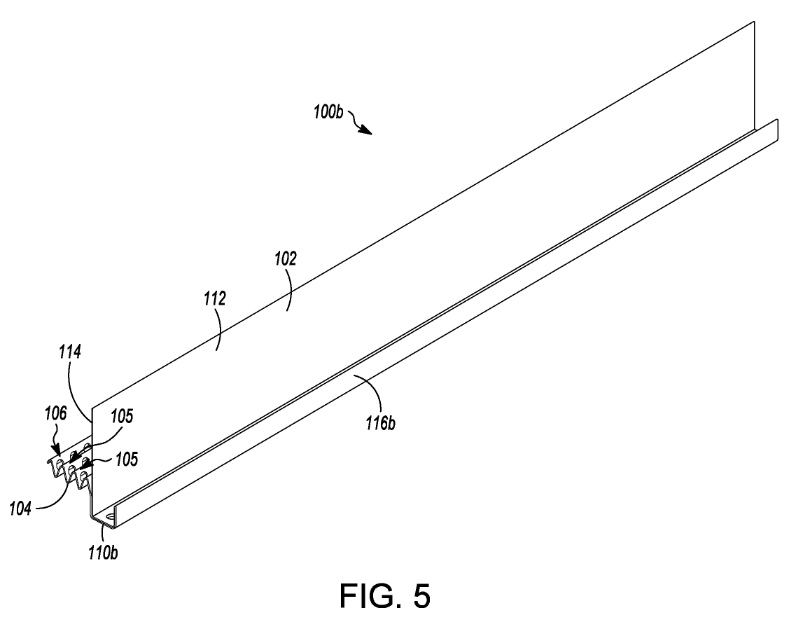

FIGS. 5 to 8, the anti-rodent trim 100b according to an alternative embodiment is depicted. Features of the anti-rodent trim 100bsimilar to those of the anti-rodent trim 100a have been labelled with the same reference numerals and will not be re-described in detail herewith. The anti-rodent trim 100bincludes an extension 110bextending from the cladding-facing surface 112 of the vertical section 104. In the present embodiment, the extension 110bis configured to contact, at least partially, a bottom surface 20 of the siding 16. In this embodiment, the extension 110bof the anti-rodent trim 100bextends perpendicularly from the cladding-facing surface 112 of the vertical section 102. In this embodiment, the extension 110bextends from a lower end 111 of the vertical section 102 such that, when assembled in the wall assembly 10, the extension 110b abuts the bottom surface 20 of the siding 16. In some embodiments, the extension 110bextends the distance of approximately 0.4 inches (1.0 cm) from the vertical section 102. However, this distance may vary in other embodiments depending on the type of siding. In this embodiment, the anti-rodent trim 100bfurther includes a ridge 116bprojecting from the extension 110b. The ridge 116bextends generally vertically from the extension 110b. In other words, the ridge 116bextends upwards, perpendicularly to the extension 110b, and in a direction substantially parallel with the vertical section 102. In some embodiments, the ridge 116b projects a distance (denoted by R) of approximately 0.3 inches (0.8 cm). However, this may vary in other embodiments depending on the type of siding. The ridge 116b engages with a recess 26 defined in the bottom surface 20 of the siding 16, the recess 26 having a generally complementary shape to receive the ridge 116b. In this embodiment, the ridge 116bis integrally formed with the extension 110b and the extension 110b is integrally formed with the vertical section 102 (and thereby integrally formed with the lateral section 104). However, in alternative embodiments, the ridge 116band the extension 110b may be formed separately from one another and from the vertical section 102 and secured to one another and the vertical section 102 using any suitable method. It is contemplated that the arrangement of the extension 110band/or the ridge 116b may be arranged differently in different embodiments.

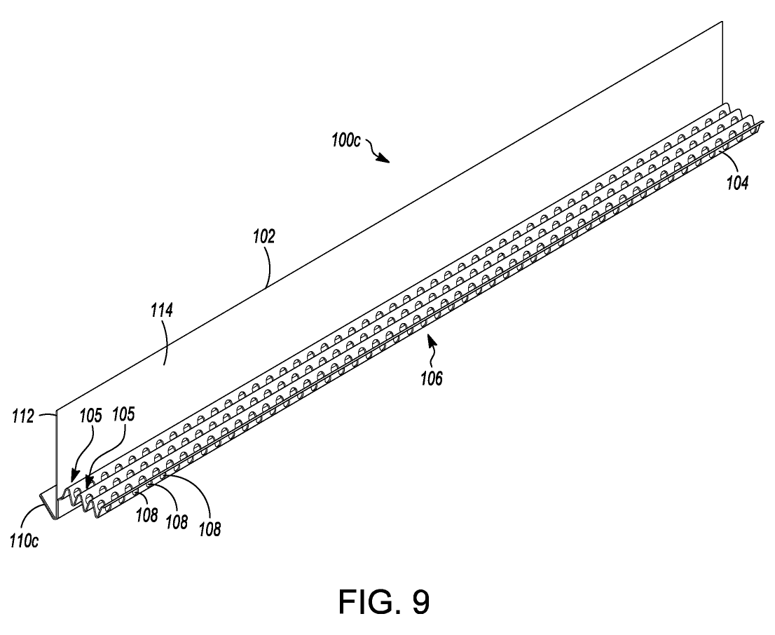

With specific reference to FIGS. 9 to 12, the anti-rodent trim 100c according to an alternative embodiment will now be described. Features of the anti-rodent trim 100c similar to those of the anti-rodent trim 100a have been labelled with the same reference numerals and will not be described in detail herewith. In this embodiment, the anti-rodent trim 100cis configured to be used with siding 16' which has a different bottom surface 20' compared to that of siding 16. The anti-rodent trim 100chas an extension 110c. The extension 110c extends obliquely from the cladding-facing surface 112 of the vertical section 102, forming an acute angle relative to the vertical section 102. In this embodiment, the extension 110bextends from the lower end 111 of the vertical section 102. When assembled in the wall assembly 10, the extension 110c engages with a recess 26' defined in the bottom surface 20' of the siding 16', the recess 26' having a generally complementary shape configured to receive the extension 110c. In some embodiments, the extension 110cextends a distance (denoted by D) of approximately 0.3 inches (0.8 cm) from the vertical section 102. However, this distance may vary in other embodiments depending on the type of siding. In this embodiment, the extension 110c is integrally formed with the vertical section 102 (and thereby integrally formed with the lateral section 104). However, in alternative embodiments, the extension 110c may be formed separately from the vertical section 102 and secured to the vertical section 102 using any suitable method.

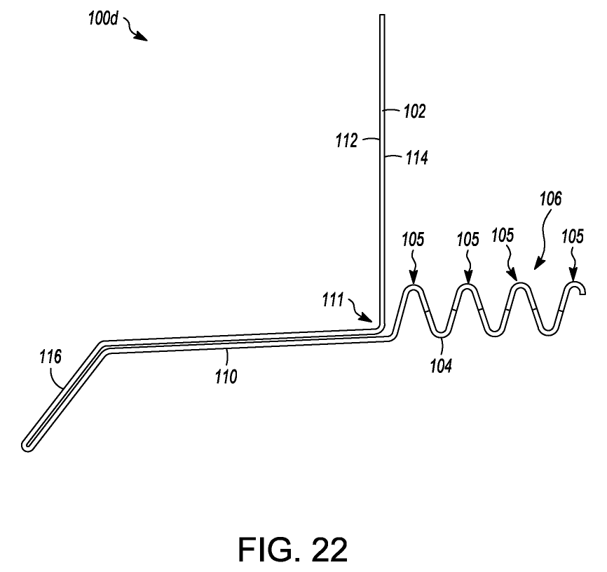

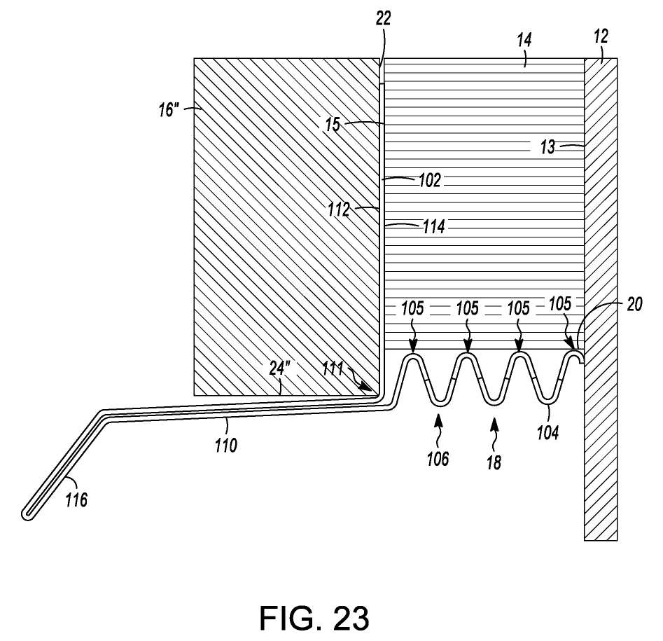

FIGS. 22 and 23, the anti-rodent trim 100d according to an alternative embodiment is depicted. Features of the anti-rodent trim 100dsimilar to those of the anti-rodent trim 100a have been labelled with the same reference numerals and will not be re-described in detail herewith. The anti-rodent trim 100dis configured to be used with brick 16'' which has a different bottom surface 20'' compared to that of the siding 16, 16'. In this embodiment, the anti-rodent trim 100d includes an extension 110d. The extension 110dextends obliquely from the cladding-facing surface 112 of the vertical section 102, forming an obtuse angle relative to the vertical section 102. In this embodiment, the extension 110d extends from the lower end 111 of the vertical section 102 such that, when assembled in the wall assembly 10, the extension 110d abuts the bottom surface 20'' of the brick 16''. In this embodiment, the anti-rodent trim 100dfurther includes a ridge 116dprojecting from the extension 110d. The ridge 116dprojects obliquely from the extension 110d, forming an obtuse angle relative to the extension 110d. However, this may vary in other embodiments. In this embodiment, the ridge 116dis integrally formed with the extension 110d and the extension 110d is integrally formed with the vertical section 102 (and thereby integrally formed with the lateral section 104). However, in alternative embodiments, the ridge 116dand the extension 110d may be formed separately from one another and from the vertical section 102 and secured to one another and the vertical section 102 using any suitable method. It is contemplated that the arrangement of the extension 110dand/or the ridge 116d may be arranged differently in different embodiments.

With reference to FIGS. 12-14, the anti-rodent trim 200 will now be described in detail. As mentioned above, the anti-rodent trim 200 is configured to be positioned at the upper portion of the wall assembly 10, such as near the roofline. It is noted that the anti-rodent trim 200 is described with reference to the siding 16; however, it may also be used with the siding 16' or the brick 16''.

Similar to the anti-rodent trim 100a, 100b, 100c, 100d, the anti-rodent trim 200 includes a vertical section 202 and a lateral section 204 extending from the vertical section 202. FIG. 14 depicts a close-up of a cross-section of the upper portion of the wall assembly 10 having the anti-rodent trim 200. In the present embodiment, the vertical section 202 of the anti-rodent trim 200 is positioned in contact with the furring strips 14. Specifically, the sheathing-facing surface 214 of the vertical section 202 abuts an outer surface 15 of the furring strip 14. In some embodiments, the vertical section 202 is secured – such as by fasteners (not shown) – to each of the furring strips 14.

The lateral section 204 extends from the cladding-facing surface 212 of the vertical section 202. In this embodiment, the lateral section 204 extends obliquely relative to the vertical section 202. However, in alternative embodiments, the lateral section 204 of the anti-rodent trim 200 may extend perpendicularly relative to the vertical section 202. When assembled, the lateral section 204 extends towards the siding 16, across at least a portion of the air gap 18 formed between the siding 16 and the sheathing 12, thereby preventing rodents from entering the air gap 18.

In some embodiments, the height of the vertical section 202 of the anti-rodent trim 200 may be approximately 1.7 inches (4.3 cm). In some embodiments, the width of the lateral section 204 of the anti-rodent trim 200 is approximately 1.0 inch (2.5 cm). It is noted that the height of the vertical section 202 and the width of the lateral section 204 may vary in other embodiments.

The anti-rodent trim 200 is integrally formed, such that the vertical section 202 and the lateral section 204 are integrally formed with one another. However, in alternative embodiments, the vertical section 202 and the lateral section 204 may be formed separately and connected together.

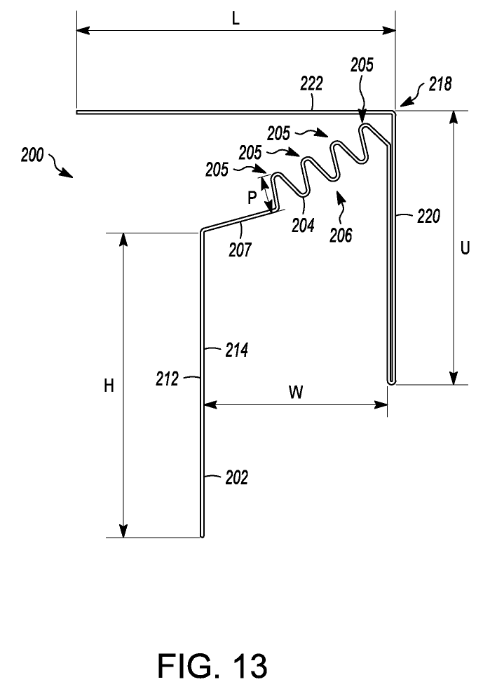

The lateral section 204 includes a series of protrusions 205 forming an undulating profile 206 extending along the width of the lateral section 204. As depicted in FIGS. 13 and 14, the undulating profile 206 extends along a portion of the lateral section 204. In other words, the lateral section 204 includes a straight segment 207 that transitions into the undulating profile 206. The lateral section 204 defines a plurality of ventilation apertures 208 spaced apart from one another. The ventilation apertures 208 provide fluid communication between the air gap 18 with the outside air, allowing for airflow therebetween to facilitate drying out any trapped moisture. In this embodiment, the ventilation apertures 208 are defined in the undulating profile 206 as well as the straight segment 207 of the lateral section 204. It is noted that the undulating profile 206 and the ventilation apertures 208 of the anti-rodent trim 200 are similar to that of the undulating profile 106 and the ventilation apertures 108 of the anti-rodent trim 100a and therefore will not be described in further detail.

As depicted in FIGS. 13 and 14, the anti-rodent trim 200 further includes a projection 218 extending from the lateral section 204. The projection 218 is spaced apart from the vertical section 202. Specifically, in this embodiment, the projection 218 and the vertical section 202 are positioned at opposite ends of the lateral section 204.

The projection 218 includes an upright portion 220 and a transverse portion 222. The upright portion 220 extends obliquely from the lateral section 204. The upright portion 220 extends in a direction parallel to the vertical section 202. When assembled, the siding 16 is positioned within a spacing 221 formed between the vertical section 202 and the upright portion 220. In this embodiment, the siding 16 is positioned such that the upright portion 220 of the projection 218 overhangs a top portion 17 of the siding 16. Additionally, a small gap (not separately numbered) is defined between the upright portion 220 and the siding 16, which fluidly connects to the outside air. The transverse portion 222 extends perpendicularly from the upright portion 220. When assembled, the transverse portion 222 extends above the lateral section 204 such that the transverse portion 222 abuts the soffit 28 of the wall assembly 10 and is, at least partially, positioned between an upper surface 30 of the furring strips 14 and the soffit 28. It is contemplated that, in other embodiments, the projection 218 may include only the upright portion 220 or only the transverse portion 222. In further embodiments, the projection 218 may be omitted.

In some embodiments, the upright portion 220 extends a distance (denoted by U) of approximately 1.5 inches (3.8 cm) from the lateral section 204. In some embodiments, the transverse portion 222 extends a distance (denoted by L) of approximately 1.7 inches (4.3 cm) from the upright portion 220. However, these may vary in other embodiments.

In this embodiment, the projection 218 is integrally formed. That is, the upright portion 220 and the transverse portion 222 are integrally formed with one another and the projection 218 is integrally formed with the lateral section 204 (and thereby integrally formed with the vertical section 202). However, in alternative embodiments, the upright portion 220 and the transverse portion 222 may be formed as separate components. Additionally, or alternatively, the projection 218 may be formed separately from the lateral section 204. Each of these components may be connected to the respective parts using any suitable method.

With reference to FIGS. 15-17, the anti-rodent trim 300 will now be described in detail. As mentioned above, the anti-rodent trim 300 is positioned above the window 32 of the wall assembly 10. It is noted that the anti-rodent trim 300 is described with reference to the siding 16; however, it may also be used with the siding 16' or the brick 16''.

Similar to the anti-rodent trim 100a, 100b, 100c, 100d, 200, the anti-rodent trim 300 includes a vertical section 302 and a lateral section 304 extending from the vertical section 302. FIG. 17 depicts a close-up of a cross-section of the wall assembly 10 having the anti-rodent trim 300. In the present embodiment, the anti-rodent trim 300 is positioned in contact with the sheathing 12. Specifically, the sheathing-facing surface 314 of the vertical section 302 abuts an outer face 13 of the sheathing 12. The vertical section 302 is secured – such as by fasteners (not shown) – to the sheathing 12.

The lateral section 304 extends from the cladding-facing surface 312. In the present embodiment, the lateral section 304 of the anti-rodent trim 300 extends substantially perpendicular to the vertical section 302. However, in other embodiments, the lateral section 304 may extend obliquely to the vertical section 302. The lateral section 304 extends across the air gap 18 towards the siding 16, thereby preventing rodents from entering the air gap 18. The lateral section 304 is positioned beneath the furring strips 14 such that a bottom surface 20 of the furring strips 14 contact the lateral section 304. It is contemplated that, in alternative embodiments, the anti-rodent trim 300 may be arranged within the wall assembly 10 differently.

In some embodiments, the height of the vertical section 302 of the anti-rodent trim 300 may be approximately 2.9 inches (7.4 cm). In some embodiments, the width of the lateral section 304 of the anti-rodent trim 300 may be approximately 0.7 inches (1.8 cm).

The anti-rodent trim 300 is integrally formed, such that the vertical section 302 and the lateral section 304 are integrally formed with one another. However, in alternative embodiments, the vertical section 302 and the lateral section 304 may be formed separately and connected together.

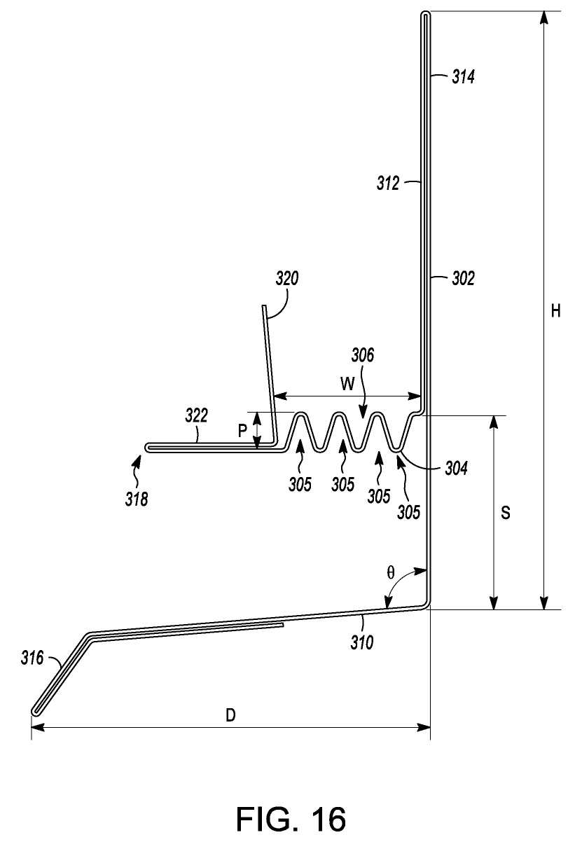

The lateral section 304 includes a series of protrusions 305 forming an undulating profile 306 extending along the width of the lateral section 304. As depicted in FIGS. 16 and 17, the undulating profile 306 extends across the entire width of the lateral section 304 of the anti-rodent trim 300. However, in other embodiments, the undulating profile 106 may extend only along a portion of the width of the lateral section 304.

The lateral section 304 defines a plurality of ventilation apertures 308 spaced apart from one another. The ventilation apertures 308 fluidly communicate the air gap 18 with the outside air, allowing for airflow therebetween to facilitate drying out any trapped moisture. In this embodiment, the ventilation apertures are defined in the undulating profile 306 of the lateral section 304.

It is noted that the undulating profile 306 and the ventilation apertures 308 of the anti-rodent trim 300 is similar to that of the undulating profile 106, 206 and the ventilation apertures 108, 208 of the anti-rodent trim 100a, 100b, 100c, 100d, 200 and therefore will not be described in further detail.

In this embodiment, the anti-rodent trim 300 includes an extension 310 extending from the cladding-facing surface 312 of the vertical section 302. The extension 310 is spaced apart from the lateral section 304. Specifically, in this embodiment, the extension 310 is spaced apart from the lateral section 304 by a distance (denoted by S) of approximately 1.0 inch (2.5 cm). However, this may vary in other embodiments. The extension 310 extends obliquely from the cladding-facing surface 314 of the vertical section 302, forming an obtuse angle relative to the vertical section 302. Specifically, the extension 310 forms an angle θ of approximately 95° with the vertical section 302. However, this may vary in other embodiments.

The extension 310 is configured to contact, at least partially, a top 35 the window 32 of the wall assembly 10. In this embodiment, the extension 310 extends from a lower end 311 of the vertical section 302, such that, when assembled in the wall assembly 10, the extension 310 extends below the lateral section 304 and engages, at least partially, with the top 35 of the window 32. In some embodiments, the extension 310 extends a distance of approximately 1.9 inches (4.8 cm) from the vertical section 302. However, this distance may vary in other embodiments.

In this embodiment, the extension 310 further includes a ridge 316 projecting from the extension 310. The ridge 316 extends obliquely from the extension 310 forming an obtuse angle with the extension 310. When assembled, the ridge 316 overhangs past an upper edge (not separately numbered) of the window 32.

In this embodiment, the ridge 316 is integrally formed with the extension 310 and the extension 310 is integrally formed with the vertical section 302 (and thereby integrally formed with the lateral section 304). However, in alternative embodiments, the ridge 316 and the extension 310 may be formed separately from one another and from the vertical section 302 and secured to one another and the vertical section 302 using any suitable method. It is contemplated that the arrangement of the extension 310 and/or the ridge 316 may be arranged differently in different embodiments.

As depicted in FIGS. 16 and 17, the anti-rodent trim 300 further includes a projection 318 extending from the lateral section 304. The projection 318 is spaced apart from the vertical section 302. Specifically, in this embodiment, the projection 318 and the vertical section 302 are positioned at opposite ends of the lateral section 304. The projection 318 includes an upright portion 320 and a transverse portion 322. The transverse portion 322 extends from the lateral section 304 in a direction substantially perpendicular to the vertical section 302. When assembled, the transverse portion 322 abuts the bottom surface 20 of the siding 16. The upright portion 320 extends obliquely from the transverse portion 322, forming an acute angle with the transverse portion 322. When assembled, the upright portion 320 is positioned between the siding 16 and the furring strips 14. In some embodiments, the upright portion 320 may be fastened to the furring strips 14. It is contemplated that, in other embodiments, the projection 318 may include only the upright portion 320 or only the transverse portion 322. In further embodiments, the projection 318 may be omitted.

In this embodiment, the projection 318 is integrally formed. That is, the upright portion 320 and the transverse portion 322 are integrally formed with one another and the projection 318 is integrally formed with the lateral section 304 (and thereby integrally formed with the vertical section 302). However, in alternative embodiments, the upright portion 320 and the transverse portion 322 may be formed as separate components. Additionally, or alternatively, the projection 318 may be formed separately from the lateral section 304. Each of these components may be connected to the respective parts using any suitable method.

With reference to FIGS. 25 and 26, the anti-rodent trim 700 will now be described in detail. As mentioned above, the anti-rodent trim 700 is positioned below the window 32 of the wall assembly 10. It is noted that the anti-rodent trim 200 is described with reference to the siding 16; however, it may also be used with the siding 16' or the brick 16''.

Similar to the anti-rodent trim 100a, 100b, 100c, 100d, 200, 300, the anti-rodent trim 700 includes a vertical section 702 and a lateral section 704 extending from the vertical section 702. FIG. 26 depicts a close-up of a cross-section of the wall assembly having the anti-rodent trim 700. In the present embodiment, the anti-rodent trim 700 is positioned in contact with the furring strips 14. Specifically, the sheathing facing surface 714 abuts an outer surface 15 of the furring strips 14. In some embodiments, the vertical section 702 is secured – such as by fasteners (not shown) – to each of the furring strips 14.

The lateral section 704 extends from the siding facing surface 712 of the vertical section 702. In this embodiment, the lateral section 704 extends perpendicularly relative to the vertical section 702. However, in alternative embodiments, the lateral section 704 of the anti-rodent trim 700 may extend obliquely relative to the vertical section 704. When assembled, the lateral section 704 extends towards the siding 16, across at least a portion of the air gap 18 formed between the siding 16 and the sheathing 12, thereby preventing rodents from entering the air gap 18.

The anti-rodent trim 700 is integrally formed, such that the vertical section 702 and the lateral section 704 are integrally formed with one another. However, in alternative embodiments, the vertical section 702 and the lateral section 704 may be formed separately and connected together.

The lateral section 704 includes a series of protrusions 705 forming an undulating profile 706 extending along the width of the lateral section 704. As depicted in FIGS. 25 and 26, the undulating profile 706 extends along the entire width of the lateral section 704. The lateral section 704 defines a plurality of ventilation apertures (not depicted) spaced apart from one another. The ventilation apertures 208 fluidly communicate the air gap 18 with the outside air, allowing for airflow therebetween to facilitate drying out any trapped moisture. In this embodiment, the ventilation apertures are defined in the undulating profile 706 of the lateral section 704. It is noted that the undulating profile 706 and the ventilation apertures of the anti-rodent trim 700 is similar to that of the undulating profile 106, 206, 306 and the ventilation apertures 108, 208, 308 of the anti-rodent trim 100a, 100b, 100c, 100d, 200, 300 and therefore will not be described in further detail.

The anti-rodent trim 700 further includes a projection 718 extending from the lateral section 704. The projection 718 includes an upright portion 720 and a transverse portion 722. The upright portion 720 perpendicularly from the lateral section 704 and in a direction parallel to the vertical section 702. When assembled, the siding 16 is positioned within a spacing 721 formed between the vertical section 702 and the upright portion 720. In this embodiment, the siding 16 is positioned such that the upright portion 720 of the projection 718 overhangs a top portion 17 of the siding 16. Additionally, a small gap (not separately numbered) is defined between the upright portion 720 and the siding 16, which fluidly connects to the outside air. The transverse portion 722 extends perpendicularly from the upright portion 720. When assembled, the transverse portion 722 extends above the lateral section 704 such that the transverse portion 722 abuts a bottom 36 of the window 32 of the wall assembly 10. In some embodiments, the transverse portion 722 may be positioned, at least partially, between the bottom 36 of the window 32 and the furring strips 14.

In this embodiment, the projection 718 is integrally formed. That is, the upright portion 720 and the transverse portion 722 are integrally formed with one another and the projection 718 is integrally formed with the lateral section 704 (and thereby integrally formed with the vertical section 702). However, in alternative embodiments, the upright portion 720 and the transverse portion 722 may be formed as separate components. Additionally, or alternatively, the projection 718 may be formed separately from the lateral section 704. Each of these components may be connected to the respective parts using any suitable method.

As discussed above, the anti-rodent trim 100a, 100b, 100c, 100d, 200, 300, 700 are integrally formed. Specifically, the anti-rodent trim 100a, 100b, 100c, 100d, 200, 300, 700 are each formed of a single sheet of roll formed metal, such as aluminum or steel, which has been bent and formed into the desired profile. In the present embodiment, the ventilation apertures 108, 208, 308, 708, were made prior to forming of the anti-rodent trim 100a, 100b, 100c, 100d, 200, 300, 700 using any suitable method such as stamping or laser cutting. It is contemplated that, in other embodiments, other suitable methods of manufacturing the anti-rodent trim 100a, 100b, 100c, 100d, 200, 300, 700 may be implemented. In some embodiments, the material of the anti-rodent trim 100a, 100b, 100c, 100d, 200, 300, 700 may be pre-painted.

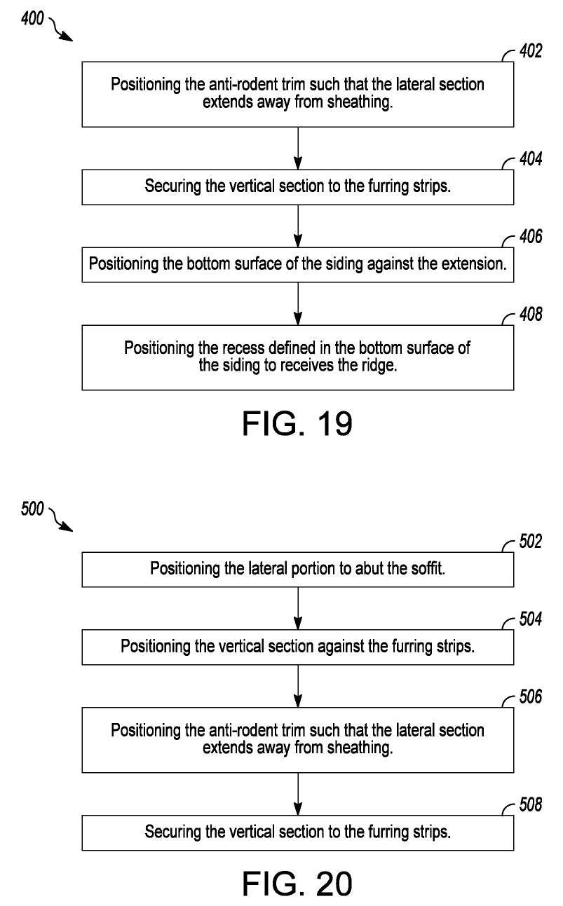

With reference to FIG. 19, a method 400 of installing the anti-rodent trim 100b will now be described in detail. It is noted that the order in which the method 400 is described is exemplary and steps may be re-ordered in other embodiments.

The method 400 begins, at step 402, with positioning the anti-rodent trim 100b. In this embodiment, step 402 comprises positioning the lateral section 104 of the anti-rodent trim 100b such that it extends away from the sheathing 12.

The method 400 continues, at step 404, with securing the vertical section 102 of the anti-rodent trim 100b to the furring strips 14. In some embodiments, the vertical section 102 is secured using fasteners. It is contemplated that, in other embodiments, the vertical section 102 may be secured to the furring strips 14 using any other suitable method. It is contemplated that, in alternative embodiments, the vertical section 102 may be secured to the sheathing 12.

The method 400 continues, at step 406, with positioning the bottom surface 20 of the siding 16 against the extension 110b.

The method 400 continues, at step 408, with positioning the recess 26 defined in the bottom surface 20 of the siding 16 to receive the ridge 116b.

It is noted that, in some embodiments, steps 406 and 408 may be omitted. For example, when installing the anti-rodent trim 100a, steps 406 and 408 are omitted. Similarly, when installing the anti-rodent trim 100cand 100d, step 408 is omitted.

With reference to FIG. 20, a method 500 of installing the anti-rodent trim 200 will now be described in detail. It is noted that the order in which the method 500 is described is exemplary and steps may be re-ordered in other embodiments.

The method 500 begins, at step 502, with positioning the transverse portion 222 of the projection 218 between the furring strips 14 and the soffit 28 of the wall assembly 10. It is contemplated that, in some embodiments, step 502 may be omitted

The method 500 continues, at step 504, with positioning the vertical section 202 to abut the furring strips 14.

The method 500 continues, at step 506, with positioning the lateral section 204 to extend across at least a portion of the air gap 18.

The method 500 proceeds, at step 508, with securing the vertical section 202 of the anti-rodent trim 200 to the furring strips 14. In some embodiments, the vertical section 202 is secured using fasteners. It is contemplated that, in other embodiments, the vertical section 302 may be secured to the furring strips 14 using any other suitable method. It is contemplated that, in alternative embodiments, the vertical section 202 may be secured to the siding 16.

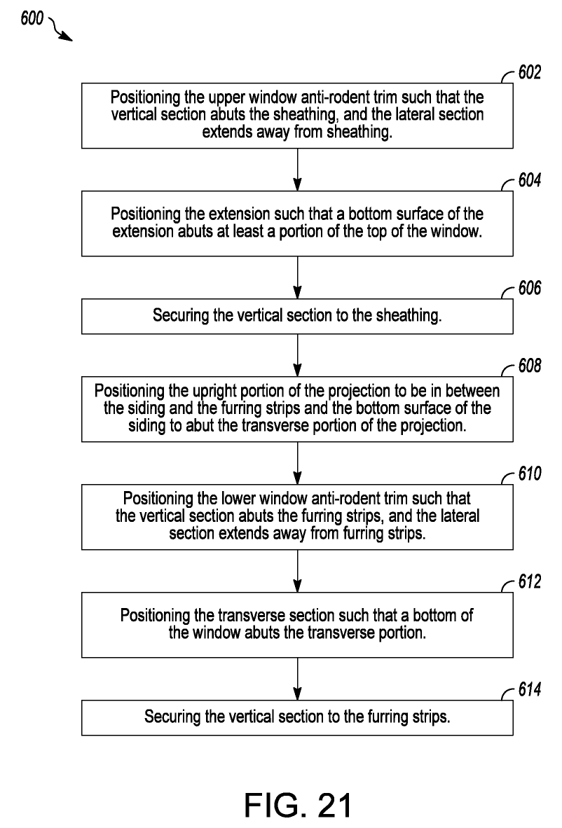

With reference to FIG. 21, a method 600 of installing the anti-rodent trim 300, 700 will now be described in detail. It is noted that the order in which the method 600 is described is exemplary and steps may be re-ordered in other embodiments.

The method 600 begins, at step 602, with positioning the anti-rodent trim 300 above the window 32. In this embodiment, step 602 comprises positioning the vertical section 302 to abut the sheathing 12 and positioning the lateral section 304 of the anti-rodent trim 300 such that it extends away from the sheathing 12.

The method 600 proceeds, at step 604, with positioning the extension 310 such that a bottom surface of the extension 310 abuts at least a portion of the top of the window 32. However, in other embodiments, step 604 may be omitted.

The method 600 continues, at step 606, with securing the vertical section 302 of the anti-rodent trim 300 to the sheathing 12. In some embodiments, the vertical section 302 is secured using fasteners. It is contemplated that, in other embodiments, the vertical section 302 may be secured to the sheathing 12 using any other suitable method. It is contemplated that, in alternative embodiments, the vertical section 302 may be secured to the furring strips 14 or the siding 16.

The method 600 proceeds, at step 608, with positioning the upright portion 320 of the projection 318 to be between the siding 16 and the furring strips 14 and the bottom surface 20 of the siding 16 to abut the transverse portion 322 of the projection 318. It is contemplated that, in other embodiments, step 608 may be omitted.

The method 600 proceeds, at step 610, with positioning the anti-rodent trim 700 below the window 32. In this embodiment, step 610 comprises positioning the vertical section 702 to abut the furring strips 14 and positioning the lateral section 704 of the anti-rodent trim 700 such that it extends away from the furring strips 14.

The method 600 continues, at step 612, with positioning the transverse portion 722 of the projection 718 to abut the bottom 36 of the window 32. It is contemplated that, in some embodiments, step 612 may be omitted.

The method 600 proceeds, at step 614, with securing the vertical section 702 of the anti-rodent trim 700 to the furring strips 14. In some embodiments, the vertical section 702 is secured using fasteners. It is contemplated that, in other embodiments, the vertical section 702 may be secured to the furring strips 14 using any other suitable method. It is contemplated that, in alternative embodiments, the vertical section 702 may be secured to the siding 16

Although the anti-rodent trims 100a, 100b, 100c, 100d, 200, 300, and 700 and the methods 400, 500, 600 for installing them have been described separately, the wall assembly 10 may incorporate any number or combination of the anti-rodent trims 100a, 100b, 100c, 100d, 200, 300, and 700.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. An anti-rodent trim for preventing rodents from entering an air gap between a cladding of a building, the anti-rodent trim having:
a first section; and
a second section extending from the first section,
the second section having at least one protrusion defined along a profile of the second section, and
the second section defining a plurality of ventilation apertures along a width of the second section.

2. The anti-rodent trim of claim 1, wherein the at least one protrusion is a series of protrusions forming an undulating profile along at least a portion of the width of the second section.

3. The anti-rodent trim of claim 2, wherein an entire width of the second section has the undulating profile.

4. The anti-rodent trim of claim 1, wherein the first section and the second section are integrally formed.

5. The anti-rodent trim of claim 1, wherein:
the second section extends from a first surface of the first section; and
the anti-rodent trim further comprises an extension extending from a second surface of the first section, the second surface being opposite of the first surface.

6. The anti-rodent trim of claim 1, wherein:
the second section extends from a first surface of the first section; and
the anti-rodent trim further comprises an extension extending from the first surface of the first section and spaced apart from the second section.

7. The anti-rodent trim of claim 5, wherein the extension is integrally formed with the first section.

8. The anti-rodent trim of claim 5, wherein the extension comprises a ridge projecting from the extension, the ridge being spaced apart from the first section.

9. The anti-rodent trim of claim 1, further comprising a projection extending from the second section, the projection being spaced apart from the first section.

10. The anti-rodent trim of claim 9, wherein the projection is integrally formed with the second section.

11. The anti-rodent trim of claim 1, wherein each of the plurality of ventilation apertures have a diameter of about 0.125 inches.

12. A wall assembly for a building comprising:
a sheathing;
a cladding spaced apart from and connected to the sheathing and defining an air gap between the cladding and the sheathing;
an anti-rodent trim having:
a vertical section contacting at least one of the cladding or the sheathing; and
a lateral section extending from the vertical section across at least a portion of the air gap to prevent rodents from entering the air gap,
the lateral section having at least one protrusion defined along a profile of the lateral section, and
the lateral section defining a plurality of ventilation apertures along a width of the lateral section, the plurality of ventilation apertures being configured to fluidly connect the air gap with outside air for ventilation.

13. The wall assembly of claim 12, further comprising:
a plurality of furring strips connected to the sheathing, each of the plurality of furring strips being spaced apart from one another; and
wherein:
the cladding is connected to the plurality of furring strips;
the vertical section of the anti-rodent trim is positioned between the plurality of furring strips and the cladding and is connected to the plurality of furring strips; and
the lateral section of the anti-rodent trim is positioned beneath the plurality of furring strips such that a base of each of the plurality of furring strips contacts the lateral section of the anti-rodent trim.

14. The wall assembly of claim 12, further comprising:
a plurality of furring strips connected to the sheathing, each of the plurality of furring strips being spaced apart from one another;
a window connected to the sheathing;
the anti-rodent trim further comprises an extension extending from a cladding-facing surface of the vertical section; and
wherein:
the cladding is connected to the plurality of furring strips;
the vertical section of the anti-rodent trim is positioned between the plurality of furring strips and the sheathing and is connected to the sheathing;
the lateral section of the anti-rodent trim is positioned beneath the plurality of furring strips such that a base of each of the plurality of furring strips contacts the lateral section of the anti-rodent trim; and
the extension of the anti-rodent trim is positioned above the window such that a bottom surface of the extension abuts at least a portion of a top of the window.

15. The wall assembly of claim 12, further comprising:
a plurality of furring strips connected to the sheathing, each of the plurality of furring strips being spaced apart from one another;
a soffit connected to the sheathing;
the anti-rodent trim further comprises a projection, the projection having a transverse portion; and
wherein:
the cladding is connected to the plurality of furring strips;
the vertical section of the anti-rodent trim is positioned between the cladding and the plurality of furring strips and is connected to the plurality of furring strips; and
the transverse portion of the projection being positioned between the plurality of furring strips and the soffit.

16. The wall assembly of claim 12, further comprising:
a plurality of furring strips connected to the sheathing, each of the plurality of furring strips being spaced apart from one another;
a window connected to the sheathing;
the anti-rodent trim further comprises a projection projecting from the lateral section, the projection having an upright portion and a transverse portion; and
wherein:
the cladding is connected to the plurality of furring strips;
the vertical section of the anti-rodent trim is positioned between the plurality of furring strips and the cladding and is connected to the plurality of furring strips; and
the transverse portion of the projection abuts a bottom of the window.

17. The wall assembly of claim 12, wherein the at least one protrusion is a series of protrusions forming an undulating profile along at least a portion of the width of the lateral section.

18. A method for installing an anti-rodent trim for a building, the method comprising:
positioning the anti-rodent trim such that a lateral section of the anti-rodent trim extends away from a sheathing of the building, the lateral section of the anti-rodent trim having an undulating profile along at least a portion of a width of the lateral section and defining a plurality of ventilation apertures along the portion of the width of the lateral section; and
securing a vertical section of the anti-rodent trim to at least one of a plurality of furring strips or a sheathing.

19. The method of claims claim 18, further comprising positioning a bottom surface of a cladding against an extension extending from the vertical section of the anti-rodent trim.

20. The method of claim 19, further comprising positioning a recess defined in the bottom surface of the cladding such that a ridge projecting from the extension of the anti-rodent trim is received in the recess.
